(19) United States
(12) Patent Application Publication
(10) Pub. No.: US 2023/0307974 A1
(43) Pub. Date: Sep. 28, 2023

(54) ELECTRIC MACHINE WITH PROTECTION AGAINST INTER-TURN SHORT CIRCUITS

(71) Applicant: Rolls-Royce Deutschland Ltd & Co KG

(72) Inventors: Johannes Gabriel BAUER, Eching (DE); Andreas REEH, Nürnberg (DE)

(21) Appl. No.: 18/032,560

(22) PCT Filed: Oct. 5, 2021
(86) PCT No.: PCT/EP2021/077448

§ 371 Date: Apr. 18, 2023

(30) Foreign Application Priority Data
Oct. 19, 2020 (DE) 10 2020 213 180.5

(51) Int. Cl. H02K 3/28; H02K 16/02

(52) U.S. Cl. CPC H02K 3/28; H02K 16/02; H02K 2213/06

(57) ABSTRACT

The invention relates to an electric machine with a protection against inter-turn short circuits, comprising a rotor with one or more permanent magnets and a stator which comprises a plurality of stator poles that are concentrically arranged about the rotor and a plurality of grooves that space the stator poles apart in the circumferential direction, wherein a yoke is arranged in each groove, said yoke forming a bridge-like connection between the stator poles in the circumferential direction, and at least one yoke winding is arranged on each yoke, said yoke winding forming an electric coil. The coil axis direction corresponds to the circumferential direction, and each pair of adjacent yoke windings surrounds a stator pole.

This application is the National Stage of International Application No. PCT/EP2021/077448, filed Oct. 5, 2021, which claims the benefit of German Patent Application No. DE 10 2020 213 180.5, filed Oct. 19, 2020. The entire contents of these documents are hereby incorporated herein by reference.

### TECHNICAL FIELD

The present embodiments relate to an electric machine with protection against inter-turn short circuits.

### BACKGROUND

Electric machines (e.g., electric motors) are increasingly used also in aircraft or automotive applications. Synchronous machines having permanently excited magnets are particularly advantageous here because they offer a high output density, torque density, and efficiency. However, the synchronous machines have the disadvantage that voltages in the stator windings, the stator windings being composed of a plurality of windings, are also permanently induced via the permanent excitation. This has the consequence that a continuous short circuit, which is referred to as an inter-turn short circuit, may be created in the event of a failure of the insulation layer between the windings. Because of the permanent excitation of the magnets, a voltage is also permanently induced in the defective component in the event of an inter-turn short circuit, which causes very high short circuit currents. These short circuit currents, which may be a multiple of a short circuit current at the terminal of the winding, lead to a great heat being able to develop locally, and to the risk of the defective component and surrounding components catching fire.

Therefore, the use of permanent magnets is advantageous by virtue of the high output density, but does have risks in terms of safety. On top of this, the electric machine in an aircraft, for example, cannot be stopped immediately when an inter-turn short circuit occurs, causing currents that continuously cause damage to be induced in the defective component.

Known solutions to this end include the installation of clutches or free-wheeling assemblies that permit the motor to be shut down, whereby construction elements on the drive, such as propellers, for example, may continue to rotate. These approaches have the disadvantage that clutches or free-wheeling assemblies have a large weight. Further, coasting of the electric machine is to be taken into account even once the electric machine has been shut down, the coasting potentially being sufficient to cause consequential damage.

For avoiding inter-turn short circuits, it is known to reinforce the insulation between the windings. However, this has the consequence of a reduced power yield and poorer cooling.

In the publication “Inter-Turn Fault Tolerant Control System in Brushless DC Motor by using Yoke Winding”, Seung-Tae Lee et al., presented in 2014 at the 17th International Conference on Electrical Machines and Systems (ICEMS), Oct. 22-25, Hangzhou, China, it is proposed to provide yoke windings in addition to the windings about the stator poles in a permanently excited electric motor. However, this has the consequence that the shorted winding is suffused by the rotor even when the winding system is shut down in the event of an inter-turn short circuit occurring in a stator pole winding. The extremely high local output loss released in the process is to be permanently dissipated. Therefore, a further combustion of the winding is to be taken into account. The purpose of the measure proposed in the document is to continue with the generation of 50% of the torque on the adjacent stator pole. Therefore, the proposed arrangement is suitable for reducing a drop in the overall output, but not for continuing to safely operate the electric machine.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, an electric machine that may continue to be safely operated with ideally little loss of output even in the event of an inter-turn short circuit is provided.

Achieved according to the present embodiments is an electric machine of the type mentioned at the outset, where at least one yoke winding that forms an electric coil is disposed on each yoke. A coil axis direction corresponds to a circumferential direction. Two adjacent yoke windings enclose in each case one stator pole.

The present embodiments are based on the concept that by disposing the stator coils on the yoke, an alternative path for the flux linkage may be provided in the event of an inter-turn short circuit in one of the coils. This leads to high short circuit currents in the defective winding being able to be avoided. Consequently, immediate stopping of the machine is also no longer necessary, but the machine may safely continue to rotate.

In the event of an inter-turn short circuit, the magnetic flux is dissipated tangentially through the yoke.

The coil affected by the inter-turn short circuit is always conjointly excited by the rotor having the permanent magnet during the operation of the electric machine. As a result of this, the affected coil as a consequence of the magnetic field caused by the induction current forms its own magnetic flux. This magnetic flux counteracts the magnetic flux of the rotor and has the effect that the resultant overall flux, thus the flux linkage, changes in the region of the defective coil. Consequently, the resultant flux is displaced from affected windings, and the flux linkage is minimized. This variation in the flux linkage depends on the disposal of the coil relative to the rotor, and on the stator geometry and the stator material.

As a result of the disposal of the coils/windings on the yoke according to the present embodiments, two flux paths running in parallel are formed. As opposed to the prior art, where the windings are disposed on the stator poles, and a winding longitudinal axis is thus disposed normally in relation to the circumferential direction, the magnetic flux in the present embodiments, in the event of an inter-turn short circuit, is not directed through regions of reduced permeability but may be formed along the stator pole and exactly parallel to a magnetic flux through the remaining “healthy” coil.

Specifically, when the flux linkage changes in such a manner that regions of low permeability (e.g., the air gap) are penetrated by the flux/magnetic field, this leads to very high short circuit currents in the shorted winding. This results in high temperatures, and an immediate stoppage is to be provided.

According to the present embodiments, the magnetic flux is guided around the location of the short circuit by the opposing magnetic field of that winding in which the inter-turn short circuit occurs, and thus the location of the failure. As a result of the stator being provided with the yoke, it is made possible that the entire magnetic flux may be formed through the remaining coil and through the highly permeable yoke. This is facilitated in that the yoke, likewise to the stator poles, is composed of a material of high permeability. If the magnetic flux is formed while facilitated by the remaining yoke, the voltage induced at the defective coil, and consequently the output loss, is conversely reduced. In the prior art, this output loss is to be permanently dissipated, and further damage to the coil is probable.

In a refinement of the present embodiments, two yoke windings are disposed on each yoke, where one stator pole is in each case enclosed by two yoke windings. One original pole coil is accordingly divided into two yoke windings.

In one embodiment, the respective two yoke windings that enclose one stator pole are electrically connected in series.

In this embodiment, the two yoke windings (e.g., coils) may be operated by a single inverter. No recirculating flux that reduces the magnetic yield of the material arises during the normal operation. In the event of an inter-turn short circuit, it is a matter of the specific machine whether the high and low sides of the bridge circuits are shut down, or whether an external bridging circuit is formed.

In one embodiment, the rotor is a double rotor and includes two concentrically disposed rotor elements having permanent magnets. For example, the two rotor elements radially surround the stator.

A disadvantage of the disposal of the windings on yokes and of the complete dispensation with pole windings lies in that the flux linkage is reduced, potentially by half. While, in a single rotor, a single stator coil per stator pole is sufficient in the prior art, according to the present embodiments, two yoke coils of the same dimensions as the stator coil are to be provided in a single rotor in order to achieve the same flux linkage. In the present embodiment having a double rotor, the flux linkage of the two yoke coils is the same as in a coil about a stator pole, where the advantageous safety effect described above is maintained. Further, a single rotor pole covers only a single stator pole. As a result of this, the torque density is increased.

In a double rotor assembly having offset stator poles, a simple possibility for detecting short circuits may, for example, be achieved by exploring coils that are wound about the yoke. There is no flux present in the yoke in the normal operation.

An asymmetry, and thus a revolving magnetic flux, arises in the event of a defect. This flux may be detected by a single sensor coil/exploring coil (e.g., that is wound about the yoke at an arbitrary position). The signal may be utilized for triggering mitigating measures (e.g., shutting down the inverter) without delay.

In one embodiment, the respective two yoke windings that enclose one stator pole are spaced apart in the circumferential direction by a width of the stator pole. The grooves utilized for the feed conductor and the return conductor of a coil are in each case offset by one groove in the circumferential direction. As a result, the north and south poles of the permanent magnets of the rotor may be disposed so as to be offset (e.g., when the rotor is a double rotor). As a result of this, the yoke is to have only a minimal cross section that suffices for the magnetic flux in the event of an inter-turn short circuit. This further facilitates that the magnetic flux through the yoke windings is formed via regions of high permeability, specifically through the stator pole.

In one embodiment, a depth of a cross section of the yoke in the radial direction is at least 0.5 times a size of a width of a stator pole in the circumferential direction. For example, the depth of the cross section of the yoke in the radial direction corresponds to the width of a stator pole in the circumferential direction.

In the event of a failure of one of the coils, the yoke absorbs the entire changed magnetic flux. The yoke is to be sufficiently dimensioned to this end. Therefore, the yoke is to have a correspondingly large cross section so as to provide a high magnetic conductivity. The higher the magnetic conductivity, the lower the short circuit current in the defective coil. A “thick” yoke therefore leads to a high weight but a low short circuit current. From the point of view of weight, an ideally “thin” yoke may therefore be provided, whereby there is the question as to which short circuit current is considered to be just acceptable, and thus does not cause any further damage. The present embodiments are based on the further concept that, given a yoke depth in the radial direction that corresponds to half the width of the stator pole in the circumferential direction, there prevails a short circuit current that is still acceptable while the motor is not excessively heavy at the same time. The short circuit current is no longer present when the depth of the yoke corresponds to the width of the stator pole. The choice of the depth of the yoke in the circumferential direction is therefore an important criterion when dimensioning the electric machine and when considering the fail-safe principle. This principle may also be applied to axial flow machines, in which instance the depth of the yoke in the axial direction would be too relevant.

In one embodiment, the electric machine includes ten rotor poles and twelve stator poles. High torque densities are possible as a result. Here too, the yoke assists in mechanically stabilizing the stator. The double rotor concept having the yoke windings may also be applied in motors in which the rotor pole pitch is very close to the stator pole pitch.

In one embodiment, the electric machine includes two electrically isolated two-phase winding assemblies of the yoke windings. Each winding assembly generates a magnetic force in the circumferential direction. The forces generated by the two half-systems cancel one another in the normal operation, there thus not being any resultant magnetic flux in the circumferential direction. As a result, a high output factor may be achieved (e.g., the effective output of the electric machine may be increased).

### BRIEF DESCRIPTION OF THE DRAWINGS

FIGS. 1a and 1b show an electric machine from the prior art;

FIGS. 2a and 2b show an electric machine from the prior art, having a double rotor assembly;

FIGS. 3a and 3b show an electric machine having a winding assembly according to an embodiment;

FIGS. 4a and 4b show an electric machine having a winding assembly according to an embodiment with a double rotor assembly;

FIG. 5 shows a schematic illustration of a magnetic flux in an electric machine with a stator pole/rotor pole ratio of 10:12; and

FIGS. 6a-c show schematic illustrations of a magnetic flux in a two-phase electric machine according to an embodiment.

### DETAILED DESCRIPTION

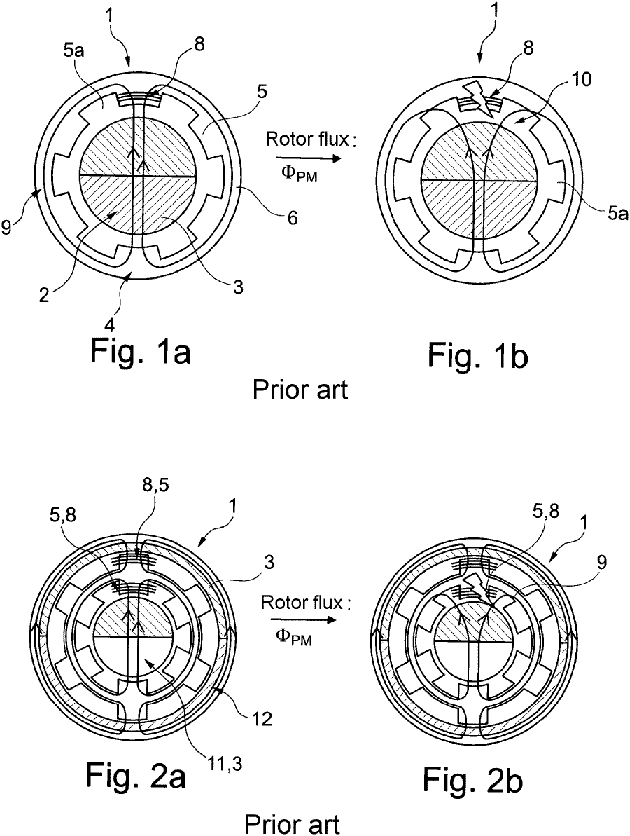

FIG. 1a shows an electric machine 1 from the prior art. The electric machine 1 includes a rotor 2 that includes a first permanent magnet 3. The electric machine 1 includes a stator 4. The stator 4 is configured as a stator ring and includes a plurality of stator poles 5. The plurality of stator poles 5 are configured as radially projecting elements of the stator ring, and are held by the stator ring. Grooves 5a that space apart the plurality of stator poles 5 in a circumferential direction are disposed between the plurality of stator poles 5. The plurality of stator poles 5 are connected to one another via bridge-like connections 6 that are disposed in the grooves 5a. The bridge-like connections 6 of the stator ring form yokes 7. Stator pole windings 8 are provided on the stator poles 5. The stator pole windings 8 form pole coils of which a longitudinal axis points toward a center of rotation of the rotor 2. In a normal operation (e.g., in the absence of a malfunction or an inter-turn short circuit in the stator pole winding 8) a magnetic flux 9 through the stator pole winding 8 is formed symmetrically on both sides of the stator pole winding 8.

FIG. 1b shows a state of the machine from FIG. 1a, in which a normal operation is no longer present, but the exemplary stator pole winding 8 is disrupted by an inter-turn short circuit. In the event of an inter-turn short circuit, there is a short circuit present between individual windings of a winding (e.g., the stator pole winding 8). The magnetic flux 9 is compromised by the inter-turn short circuit. The permanent excitation of the permanent magnet 3 of the rotor 2 leads to voltages and thus currents being continuously induced in the defective stator pole winding 8. This results in overheating of the pole coil, which may lead to the combustion of the electric machine 1. An opposing magnetic field (not illustrated) that deflects the magnetic flux 9 from FIG. 1a and leads to the magnetic flux 9 being formed according to FIG. 1b is caused by the short circuit currents. The changed magnetic flux 9 in FIG. 1b now no longer is routed through the stator pole 5 but through an air gap 10 between the stator ring and the rotor 2. In contrast to the stator pole 5, the air gap 10 is, however, a region of reduced permeability. This leads to significant short circuit currents.

FIG. 2a shows an electric machine 1 from the prior art, having a double rotor assembly. The rotor 2 includes a first, inner rotor element 11 and a second, outer rotor element 12. The first and the second rotor elements 11, 12 are concentrically disposed and surround the stator 4. The rotor elements 11, 12 carry permanent magnets 3. The stator poles 5 of the stator 4 are disposed so as to project inward and outward in a radial direction, and each carry stator pole windings 8.

FIG. 2b shows the electric machine 1 from FIG. 2a, in which an inter-turn short circuit has occurred in the inner stator coil 8. The magnetic flux 9 is deflected as a result and penetrates regions of reduced permeability (e.g., air gap 10), leading to high short circuit currents.

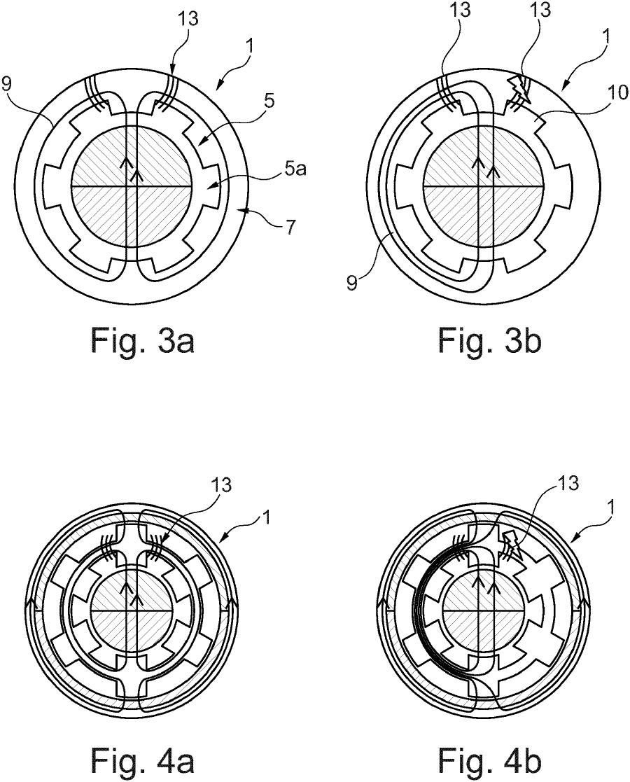

FIG. 3a shows an electric machine 1 according to an embodiment. In contrast to the electric machine from FIGS. 1a, 1b, 2a, and 2b, the stator pole 5 does not carry any stator pole windings 8. No pole coils are present. Yoke windings 13 are disposed on each one of the yokes 7. The yoke windings 13 form electric coils (e.g., yoke coils). The coil axis directions of the yoke coils correspond approximately to the circumferential direction of the stator 5. Two yoke coils are disposed on each yoke, where one stator pole 5 is in each case enclosed by two yoke coils. The yoke coils are disposed in the grooves 5a and disposed so as to be offset toward a respective stator pole 5. The yoke windings are in each case spaced apart in the circumferential direction at least by a width of the stator pole 5. Yoke coils of the two adjacent teeth are to be accommodated in each groove. For this reason, the coil 13 is not plotted in a center of a slot.

In a normal operating state, the magnetic flux 9 is formed in a manner analogous to the magnetic flux 9 in the machine from FIG. 1. The yoke 7 in the radial direction is dimensioned such that the cross section thereof has an additional depth (e.g., a radial extent) that is at least half the size of the width of a stator pole 5 in the circumferential direction. It is provided as a result that the yoke 7 is sufficiently dimensioned so as to absorb the magnetic flux and to have a sufficiently low magnetic resistance. The dimensioning of the yoke 7 influences the size of the short circuit current in the defective yoke coil. A short circuit current in the defective coil may no longer be ascertained, for example, when the depth of the cross section of the yoke 7 corresponds to the width of the stator pole.

FIG. 3b shows the electric machine from FIG. 3a, in which an inter-turn short circuit has occurred in one of the yoke coils 13. The magnetic flux 9 is deflected by the opposing magnetic field generated in the yoke coil 13. In contrast to the machine from FIG. 1b, the changed magnetic flux, however, does not run through regions of reduced permeability (e.g., the air gap 10), but runs parallel to the magnetic flux through the intact yoke coil 13 lying opposite. The changed magnetic flux runs through regions of high permeability (e.g., still through the stator pole 5 but not through the air gap 10). Output losses are reduced as a result. The yoke coils are electrically connected in series so as to avoid a recirculating flux in the normal operation.

FIG. 4a shows the electric machine 1 from FIGS. 3a and b having a double rotor. In a normal operating state, the magnetic flux is formed in a manner analogous to the magnetic flux in the electric machine from FIG. 2a.

FIG. 4b shows the electric machine 1 from FIG. 4a, in which an inter-turn short circuit has occurred in one of the yoke coils 13. Here too, the magnetic flux, which is created as a consequence of the deflection by the opposing magnetic field induced by the defective yoke coil, is formed so as to be parallel to the magnetic flux by the remaining intact yoke coil, and is therefore not routed through regions of reduced permeability.

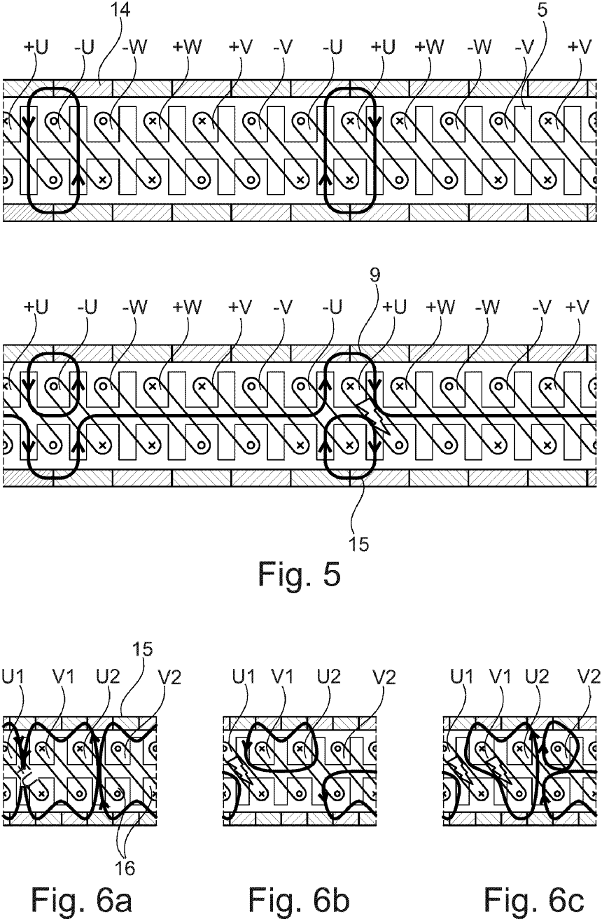

FIG. 5 shows an electric machine 1 according to an embodiment. The electric machine 1 of FIG. 5 includes a double rotor having ten rotor poles and twelve stator poles 5. The upper drawing of FIG. 5 shows a normal operating state and formation of the magnetic flux therein. In the lower drawing of FIG. 5, there is an inter-turn short circuit present in one of the yoke windings. The defective yoke winding generates an opposing magnetic field 15 that leads to a deflection of the magnetic flux 9. By virtue of a fine pole pitch, high torque densities may be achieved with this machine type. The known machines of this type avoid a yoke 7 in order to additionally increase the torque density. However, a yoke is added for routing the flux tangentially in the event of a short circuit (see image 10). The yoke coils are offset by the width of one groove. This enables the alignment of the north and south poles of the two rotor elements 11, 12, and the yoke 7 is not exploited by the magnetic flux during normal operation. The yoke 7 may therefore be constructed using minimal dimensions. Additionally, the yoke 7 contributes toward the structural stability of the stator 4 and enables the separation of the individual yoke coils in the single-layer winding diagram. The concept may also be implemented as a dual-layer winding diagram. A further variant is the use of the yoke coils on a multi-track machine.

FIGS. 6a-c show an electric machine as described in the context of FIG. 5, but with two separate two-phase winding systems 16. Each two-phase winding system 16 generates a revolving magnetic force. However, the magnetic forces counteract one another and have the effect that no revolving magnetic flux is created in the symmetrical operation (e.g., the operation with two intact yoke coils). This leads to a high output factor.

FIG. 6b shows the operation of the electric machine 1 from FIG. 6a with an inter-turn shorting circuit. As discussed in the context of FIG. 3, the failure current is limited.

FIG. 6c shows the failure mode with a clamping circuit in the first winding system and an open circuit in the second winding system. This case corresponds to a DC intermediate circuit shorting in a winding system. Owing to the asymmetrical operation (e.g., operation with only one intact yoke coil), a revolving flux is generated. The revolving flux drives the short circuit currents significantly below the value that is expected from the output factor under symmetrical conditions. This enables designs with a high output factor at normal operation, and minor short circuit currents by virtue of the increase in inductance when a yoke coil fails.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. An electric machine with protection against inter-turn short circuits, the electric machine comprising:
a rotor having one or permanent magnets; and
a stator comprising:
a number of stator poles that are disposed concentrically about the rotor; and
a number of grooves space apart the number of stator poles from one another in a circumferential direction, wherein one yoke that, in the circumferential direction, forms a bridge-like connection between the number of stator poles is disposed in each of the number of grooves,
wherein at least one yoke winding that forms an electric coil is disposed on each of the yokes,
wherein a coil axis direction corresponds to the circumferential direction, and
wherein two adjacent yoke windings of the yoke windings enclose, in each case, one stator pole of the number of stator poles.

2. The electric machine of claim 1, wherein two of the yoke windings are disposed on each of the yokes,
wherein one stator pole of the number of stator poles is in each case enclosed by respective two yoke windings of the yoke windings.

3. The electric machine of claim 2, wherein the respective two yoke windings that enclose the one stator pole are electrically connected in series.

4. The electric machine of claim 1, wherein the rotor is a double rotor and comprises two concentrically disposed rotor elements having permanent magnets .

5. The electric machine of claim 2, wherein the respective two yoke windings that enclose the one stator pole are mutually spaced apart in the circumferential direction by a width of the one stator pole.

6. The electric machine of claim 1, wherein a depth of a cross section of the one respective yoke in a radial direction is at least 0.5 times a size of a width of a stator pole of the number of stator poles in the circumferential direction, .

7. The electric machine of claim 1, wherein the rotor comprises ten rotor poles, and
wherein the number of stator poles comprises 12 stator poles.

8. The electric machine of claim 1, further comprising two electrically isolated two-phase winding assemblies of the yoke windings.

9. The electric machine of claim 4, wherein the two concentrically disposed rotor elements radially surround the stator.

10. The electric machine of claim 6, wherein the depth of the cross section of the one respective yoke in the radial direction corresponds to the width of a stator pole in the circumferential direction.

11. The electric machine of claim 3, wherein the rotor is a double rotor and comprises two concentrically disposed rotor elements having permanent magnets.

12. The electric machine of claim 11, wherein the respective two yoke windings that enclose the one stator pole are mutually spaced apart in the circumferential direction by a width of the one stator pole.

13. The electric machine of claim 12, wherein a depth of a cross section of the one respective yoke in a radial direction is at least 0.5 times a size of a width of a stator pole of the number of stator poles in the circumferential direction.

14. The electric machine of claim 13, wherein the rotor comprises ten rotor poles, and
wherein the number of stator poles comprises 12 stator poles.

15. The electric machine of claim 14, further comprising two electrically isolated two-phase winding assemblies of the yoke windings.
